(19) United States
(12) Patent Application Publication
(10) Pub. No.: US 2008/0162150 A1
(43) Pub. Date: Jul. 3, 2008

(54) System and Method for a High Performance Audio Codec

(75) Inventor: Veeru Ramaswamy, Virginia Beach, VA (US)

Correspondence Address: STOLL KEENON OGDEN PLLC, 2000 PNC PLAZA, 500 WEST JEFFERSON STREET, LOUISVILLE, KY, 40202-2828, US

(73) Assignee: Vianix Delaware, LLC, Virginia Beach, VA (US)

(21) Appl. No.: 11/956,979

(22) Filed: Dec. 14, 2007

Related U.S. Application Data
(60) Provisional application No. 60/877,449, filed on Dec. 28, 2006.

(51) Int. Cl. G10L 19/00

(52) U.S. Cl. 704/500; 704/E19.033

(57) ABSTRACT

A system for a high performance audio codec provides higher voice quality and higher recognition accuracy from an ASR engine at an increased data rate and computational power and embodiments include those having a CELP-based codec, an ASR engine, a text comparator, an encoder, a decoder, an LPC Computation and formant analysis module, a dual stage data rate determination module, a VQ of LSP coefficients module, a pitch synthesis and optimal pitch parameter search module, and an excitation codebook parameter search module. A method for high performance audio codec includes three stages and comprises the steps of having an ASR engine yield transcribed text from each of an uncompressed reference signal and a decompressed signal that has passed through an encoder and wherein the transcribed text is compared with original text to determine word error rates in an iterative process whereby both voice quality and recognition accuracy are optimized.

### BRIEF DESCRIPTION OF THE DRAWINGS

FIG. 1a is a flow diagram of a procedure performed by an embodiment wherein Stage 1 occurs before Stage 2.

FIG. 1b is a flow diagram of a procedure performed by an embodiment wherein Stage 1 occurs simultaneously with Stage 2.

FIG. 2 is a logic flow diagram of an embodiment showing further details of Stage 3 computed from Stages 1 and 2.

FIG. 3 is a logic flow diagram of an embodiment showing details within an encoder.

### MULTIPLE EMBODIMENTS AND ALTERNATIVES

The System and Method for a High Performance Audio Codec 10 relates broadly to voice processing and codes and, more particularly, to an audio Codec 10 which will produce high voice quality and recognition accuracy from an automatic speech recognition (ASR) engine 12. In multiple embodiments, the ASR engine 12 includes features as desired, such as, for example, a transcription engine, a speech analytics engine, a voice biometrics engine, an interactive voice response (IVR) engine, a language learning engine, and a language translation engine. Furthermore, the ASR engine 12, as desired, is embedded or network-based. Embodiments include those wherein the ASR engine 12, as desired, is phonetic or large vocabulary continuous speech recognition (LVCSR).

A Codec is a method of functional steps by which data such as audio, video or text data is compressed by encoding, and decompressed by decoding. A voice/speech/audio Codec is a method of steps to compress and decompress voice, speech or audio signals. Compression is selectably performed as lossy or lossless. In a lossless compression scheme and with regard to binary bits, the audio information is recovered completely.

When lossy compression is performed, certain data may be lost in the process of compressing or decompressing any sort of data signal. If the data signal being compressed is a voice, speech or audio signal file, such a data loss may be detrimental to a resultant signal once it is processed for automatic speech recognition.

Accordingly, embodiments of the Codec 10 provide a high voice quality along with high recognition and accuracy from the ASR engine 12 while also maintaining data transfer rates and computational power over prior systems.

Reproduced voice quality is measured by the term Perceptual Evaluation of Speech (PESQ). In the industry, ITU P.861, an International Telecommunication Union recommendation, is used for calculating telephone call quality. Among methods for calculating telephone call quality, ITU P.861 uses either PESQ, an objective measure; or MOS (Mean Opinion Score), a subjective measure.

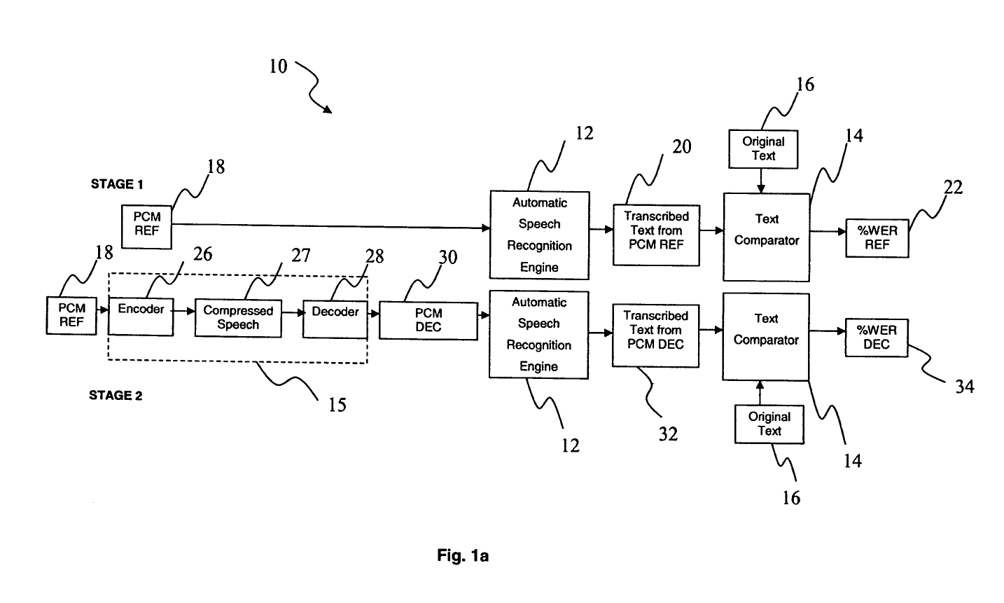

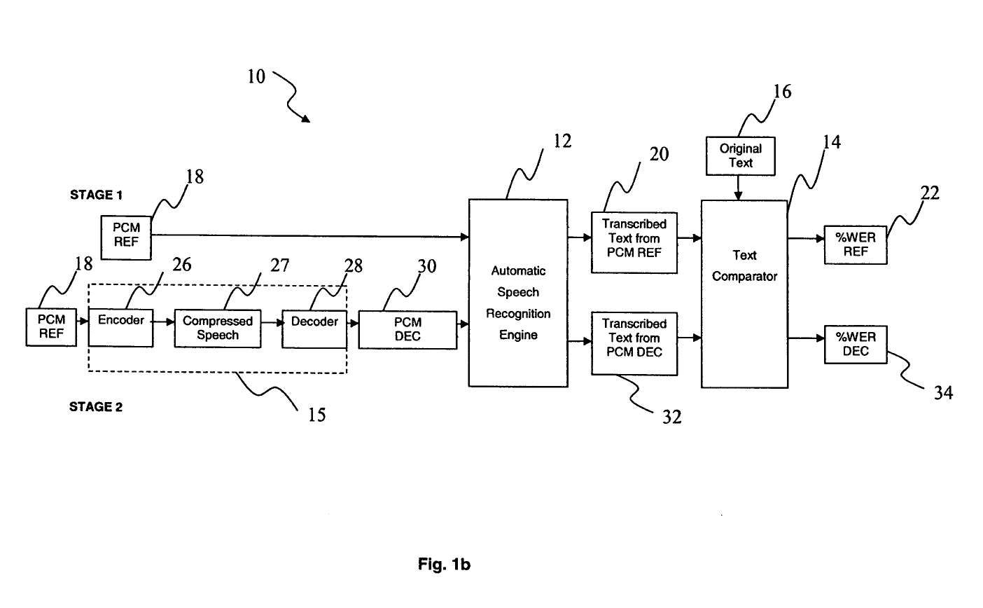

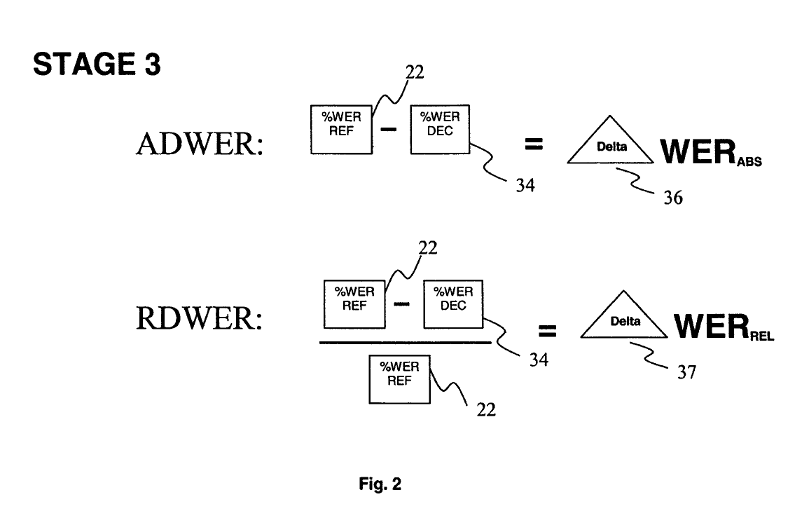

Referring to FIGS. 1a, 1b and 2, with specific attention to the provided flow diagrams, we see that the system and method is illustrated generally at 10 achieves a recognition accuracy determination process and has three stages. Stage 1 and Stage 2 are illustrated in FIGS. 1a and 1b. Stage 3 is a computational result obtained from Stages 1 and 2 and is illustrated in FIG. 2.

Recognition accuracy is measured in terms of a Word Error Rate, abbreviated as WER, which is the number of words out of, for example, 100 words that are inaccurately recognized by the automatic speech recognition engine. The lower the WER value, the better the recognition accuracy. A Percent WER, abbreviated as % WER, is determined by comparing the original words with the words that result from use of the system and method 10. Specifically, % WER is determined by summing up the total number of inaccurately recognized words, dividing that sum by the total number of words, and then multiplying the result by 100. As will be described in more detail following at Stage 3, and shown in FIG. 2, the recognition accuracy is further analyzed using the term Delta WER (Delta Word Error Rate), or ΔWER. ΔWER means the change in word error rate between a reference/uncompressed signal and a decoded/decompressed signal.

Referring to FIGS. 1a and 1b and at Stage 1, the input speech is an uncompressed reference signal. Embodiments and alternatives of the system and method provide an uncompressed reference signal such as, for example, a pulse code modulated reference signal. Both Stage 1 and Stage 2 operate through the ASR engine 12. The ASR engine 12 is in communication with a text comparator 14 for comparison with original text 16, which is input directly to the text comparator 14, thereby allowing the determination of recognition accuracy.

In further detail, and by example, referring in particular to FIGS. 1a and 1b at Stage 1, a pulse code modulator generates a reference signal, PCM REF 18, which is sent to the ASR engine 12. The ASR engine 12 operates on the PCM REF 18 by producing text data 20 which is transcribed text from PCM REF 18. As desired, the PCM REF 18 is in a narrow band, from 8 kHz to 11 kHz sampling frequency, inclusive; or in a wide band, at or above 16 kHz sampling frequency. Furthermore, the PCM REF 18 has an audio sample byte size of 8-bit, 16-bit, 32-bit, 64-bit or any other byte size as desired. The text comparator 14 compares the text data 20 from the ASR 12 with the original text 16 in order to determine a percent word error rate, as discussed above, and specifically for Stage 1 as % WER REF 22, for the PCM REF 18.

At Stage 2, embodiments include those in which the same pulse coded modulated reference signal, PCM REF 18, is sent to an encoder 26, yielding Compressed Speech 27. The Compressed Speech 27 is sent to a decoder 28, yielding a decoded signal which is a PCM Decompressed signal, PCM DEC 30. The combination of the encoder 26 and the decoder 28, together form the codec 15 in its multiple and alternative embodiments. The operation of the codec 15 yields PCM DEC 30 which is fed to the ASR engine 12 which then operates on PCM DEC 30, yielding transcribed text 32 from PCM DEC 30. The transcribed text 32 is then sent to the text comparator 14 which compares the transcribed text 32 from the ASR 12 with the original text 16 in order to determine a percent word error rate, as discussed above, and illustrated in the Figs. specifically for Stage 2 as % WER DEC 34, for the PCM DEC 30.

For the sake of clarity, and as shown in FIG. 1a, Stage 1 may occur, as desired, in a sequence illustrated generally from left to right in FIG. 1a, yielding % WER REF 22. Stage 2 may then occur after Stage 1, as desired and also in a sequence illustrated generally from left to right in FIG. 1a, yielding % WER DEC 34. Alternative embodiments provide, as shown in FIG. 1b, that Stage 1 and Stage 2 may occur simultaneously wherein ASR Engine 12 receives PCM REF 18 from Stage 1 while also receiving PCM DEC 30 from Stage 2 and the ASR Engine 12 operates on both signals simultaneously. Note further that transcribed text 20 from PCM REF 18 is distinct from transcribed text 32 from PCM DEC 30. Furthermore, alternative embodiments provide that both sets of text data 20, 32 are operated on within the text comparator 14 and as previously described in detail herein.

At Stage 3, as shown in FIG. 2, embodiments of the system and method 10 compute the previously discussed ΔWER as an absolute difference (ADWER) and illustrated as ΔWER_{Abs}36. Alternatives provide the previously discussed ΔWER as a relative difference (RDWER) and illustrated as ΔWER_{Rel} 37. For example, ΔWER_{Abs}36 is the difference between the % WER REF 22 and the % WER Dec 34. ΔWER_{Rel} 37 is the ΔWER_{Abs}36 divided by the % WER REF 22.

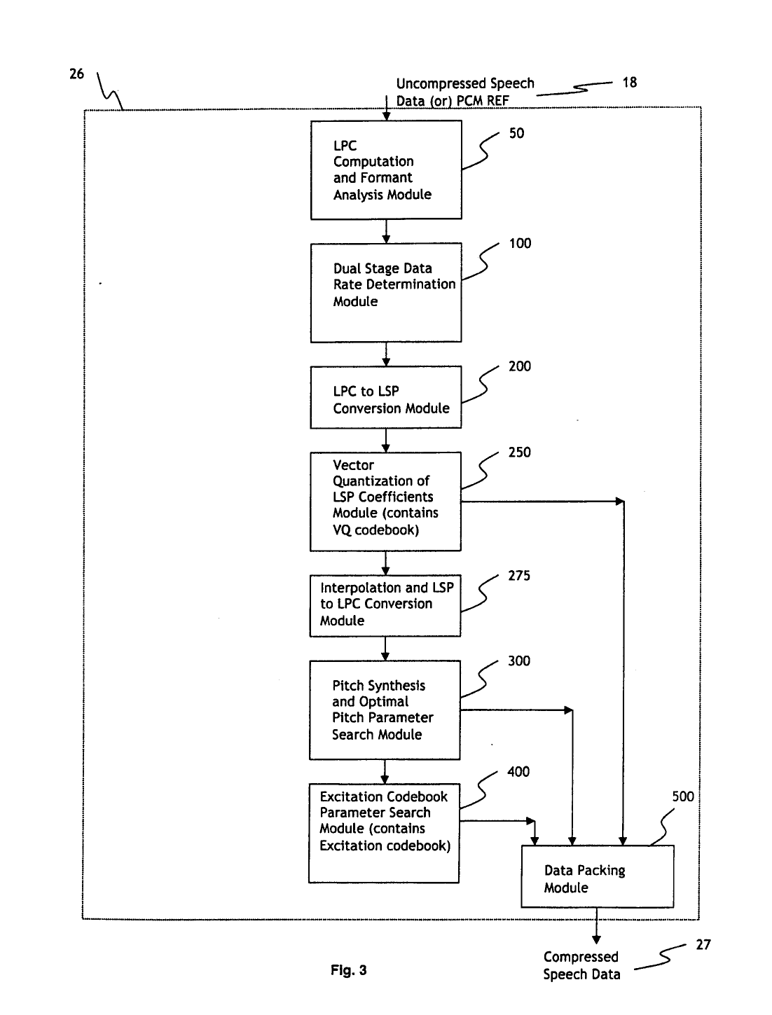

Referring to FIG. 3, multiple embodiments and alternatives of the system and method 10 include the Codec 15 and further comprise three main modules including:

a Vector Quantization (VQ) of LSP Coefficients Module 250 which contains a VQ Codebook,

a Pitch Synthesis and Optimal Pitch Parameter Search Module 300; and,

an Excitation Codebook Parameter Search Module 400 which contains an Excitation Codebook.

In addition, there are other modules which are related to the codec 15 and they include:

an LPC Computation and Formant Analysis Module 50,

a Dual Stage Data Rate Determination module 100,

an LPC to LSP Conversion Module 200 wherein LSP means Line Spectral Pair,

an Interpolation and LSP to LPC Conversion Module 275 for either or both of pitch synthesis and the decoder 28; and,

a Data Packing Module 500 having, as desired, a packing portion for the encoder 26, and an unpacking portion for the decoder 28.

The multiple embodiments and alternatives provide a codec 15 featuring improvements from the perspectives of voice quality and accuracy of voice recognition. Having mentioned the modules which comprise the system and method 10 of the embodiments and alternatives, we turn our attention to a more detailed discussion of topics concerning several of the modules of interest: 1) the LPC Computation and Formant Analysis Module 50 with LPC to LSP Conversion Module 200 along with the VQ of LSP Coefficients Module 250, 2) the Pitch Synthesis and Optimal Pitch Parameter Estimation Module 300; and, 3) the Excitation Codebook Parameter Search Module 400. Taking each of these topics in turn, we begin with the:

1) LPC Computation and Formant Analysis Module 50 with LPC to LSP Conversion Module 200 Along with the VQ of LSP Coefficients Module 250

Embodiments and alternatives of the Codec 15 are based on a CELP algorithm. Embodiments include CELP-based algorithms such as, for example, a MASC-type codec. MASC (Managed Audio Sound Compression) is a CELP-based algorithm, proprietary to Vianix, LLC. CELP-based algorithms typically use LPC filters. MASC embodiments use tenth order LPC filters in order to accurately model resonances and general spectral shape of speech signals. The LPC filters are also referred to as short term predictors (STP) which model and capture the short-term correlation of speech signals.

Embodiments of the present codec 15 generate pairs of odd and even roots, the roots denoted as “X” and “Y”, from LPC coefficients. If “n” pairs are produced, then the order of the LPC filters is simply “n” multiplied by 2, or “2n.” For example, alternatives include those wherein the codec 15 generates five pairs of odd and even roots from LPC coefficients, and correspondingly, tenth order LPC filters. Such roots are known as Line Spectral Pair (LSP) coefficients. These five pairs are rearranged and each pair is vector quantized utilizing the Vector Quantization (VQ) of LSP Coefficients Module 250 and utilizing a VQ codebook wherein the pairs are found as entries VQ₁ through VQ₅ in the VQ codebook. The parameters of size and length are of concern with regard to entries in the VQ codebook. Size refers the number of dimensions for each entry. Length refers to the number of entries in the codebook. Embodiments provide a VQ codebook of dimension 2 having pairs of roots in the form of X and Y together comprising one entry, such as, in the example above, VQ₁, and generated from the Vector Quantization (VQ) of LSP Coefficients Module 250 using an algorithm such as, for example, LBG (Linda-Buzo-Gray), also known as GLA (Generalized Lloyd Algorithm), which was used in the 1980's for the development of efficient vector quantizer codebooks. Embodiments of Codec 15 include alternatives having a VQ codebook and wherein parameters such, for example, an optimal size and an optimal length of the VQ codebook are determined. The LBG algorithm provides a most probable value for a given set of LSP's. The number of probable values to be generated is the length of the codebook. Because it is important that these input LSP coefficients cover all sorts of speech signals, embodiments include those using LSP coefficients from various speech test vectors wherein the maximum number of LSP coefficients in the VQ codebook is 2048. Vector quantization of the LSP is also based on two other parameters: the sensitivity weights (SW) and the Mean Square Error (MSE). The sensitivity weights (SW) relate to the sensitivity of each of the VQ codebook vectors and of the excitation codebook vectors on the speech signal. Furthermore, the sensitivity weights are obtained by cross-correlating the auto-correlation coefficients of the speech signal with a determined number of coefficients obtained from the LSP frequencies. Embodiments provide that a sensitivity-weighted mean square error (MSE_{sw}) between the quantized and unquantized LSP frequencies is shown as MSE_{sw} and that the MSE_{sw} is computed as follows:

MSE_{sw}=SWₒ(wₒ−wqₒ)²+SWₑ(wₑ−wqₑ)²

### Where,

SWₒ is the sensitivity weight of the odd pair.
SWₑ is the sensitivity weight of the even pair.
wₒ is the unquantized odd Linear Spectral Frequency (LSF).
wₑ is the unquantized even Linear Spectral Frequency (LSF).
wqₒ is the quantized odd Linear Spectral Frequency (LSF).
wqₑ is the quantized even Linear Spectral Frequency (LSF).

The output from the VQ of LSP Coefficients Module 250 is sent to the packing portion for the encoder 26 of the Data Packing Module 500 and also to the Interpolation and LSP to LPC Conversion Module 275, which sends its output to the Pitch Synthesis and Optimal Pitch Parameter Search Module 300.

### 2) Pitch Synthesis and Optimal Pitch Parameter Search Module 300

Embodiments provide that each frame (with alternatives including those wherein a value of 20 milli-seconds is utilized) in the previous module 250 is further subdivided into 5 milli-second subframes. The Pitch Synthesis and Optimal Pitch Parameter Search Module 300 determines pitch synthesis and optimal pitch search of the subframes by interpolating LSP Frequencies from the VQ codebook and obtaining their corresponding LPC coefficients. The LPC coefficients are obtained using a formant synthesis (an LPC to LSP conversion). Next, a closed loop pitch search is performed on the LPC coefficients using an analysis by synthesis approach. This module 300 will yield two parameters: 1) the Pitch Gain, and, 2) the Pitch Lag, which are both sent to the packing portion for the encoder 26 of the Data Packing Module 500 and to the Excitation Codebook Parameter Search Module 400.

### 3) Excitation Codebook Parameter Search Module 400

Regarding the excitation codebook parameter search module 400, it should be noted that the excitation codebook has two parameters for each codebook sub frame:

1) Excitation Codebook Index I; and,

2) Excitation Codebook Gain G.

The codebook parameters specify the excitation pitch filter. The synthesized speech is obtained from the scaled codebook vector, filtered by the pitch synthesis filter and the format synthesis filter. In other words, the synthesized speech is the output of the formant synthesis filter that processes the estimated output of the pitch synthesis filter. The excitation codebook consists of stochastic entries. When each entry is given to a speech model as an input, a vector is obtained that pertains to the signal of interest by the use of mean square error methodology. Embodiments achieve a goal of codebook search in that embodiments minimize the mean square error between the input speech 18 and synthesized speech and thereby determine the optimal size of the excitation codebook. Efficient excitation codebook entries for the encoder 26 are generated stochastically to see that the MSE_{sw} is reduced. The previously mentioned Vector Quantization (VQ) of LSP Coefficients Module 250 sends and receives signals from the excitation codebook parameter search module 400 in order to achieve the stochastic generation and reduction of MSE_{sw}. As desired, the process of efficient excitation codebook generation serves to optimize the order of the LPC filters as previously discussed, and is stopped when satisfactory reduction and MSE_{sw} is achieved. Embodiments and alternatives include those wherein parameters such as, for example, the optimal size of the excitation codebook are determined.

Referring to the Figures, embodiments and alternatives are provided for a method for high performance audio Codec comprised of the steps:

For Stage 1:

Input speech as an uncompressed reference signal such as, for example, PCM REF 18, is sent to the ASR Engine 12, bypassing the audio Codec 15, whereby the ASR engine 12 yields transcribed text 20 from the uncompressed reference signal, PCM REF 18,

The transcribed text 20 from the uncompressed reference signal, PCM REF 18, is also sent to the text comparator 14 which compares the transcribed text 20 from the PCM REF 18 received from the ASR engine 12 with the original text 16 in order to determine a percent word error rate, % WER REF 22, with respect to the PCM REF 18,

For Stage 2:

input speech is sent to the encoder 26 of the audio Codec 15 as an uncompressed reference signal, such as, for example, PCM REF 18,

The encoder 26 yields compressed speech 27,

The compressed speech 27 from the encoder 26 is sent to the decoder 28 yielding a decoded signal in the form of a decompressed reference signal, such as, for example, PCM DEC 30,

The PCM DEC 30 is sent to the ASR Engine 12 yielding transcribed text 32 from the PCM DEC 30,

The transcribed text 32 from the PCM DEC 30 is sent to the text comparator 14 which compares the transcribed text 32 from the PCM DEC 30 received from the ASR engine 12 with the original text 16 in order to determine a percent word error rate, such as, for example, % WER DEC 34, with respect to the PCM DEC 30,

For Stage 3:

Referring specifically to FIG. 2, a ΔWER is computed as a function, such as, for example, an absolute word error rate (ADWER) shown as ΔWER_{Abs} 36, or a relative word error rate (RDWER) shown as ΔWER_{Rel} 37 of the % WER REF and the % WER DEC.

ΔWER_{Abs} equals the % WER DEC 34 subtracted from the % WER REF 22.

ΔWER_{Rel} 37 equals the ΔWER_{Abs} 34 divided by the % WER REF 22.

Referring to FIG. 3, the method for high performance audio Codec at Stage 2, the input speech is sent to an encoder of the audio Codec as an uncompressed reference signal further comprises that the PCM REF 18 is passed through modules within the encoder 26 selected from the group dual stage data rate determination module 100, vector quantization of LSP coefficients module 250, pitch synthesis and optimal pitch parameter search module 300, and excitation codebook parameter search module 400. Furthermore, alternatives of the method embodiments include those wherein the vector quantization of LSP coefficients module 250 contains a VQ codebook and the excitation codebook parameter search module 400 contains an excitation codebook.

For the sake of clarity as to the method, and as shown in FIG. 1a, Stage 1 may occur, as desired, in a sequence illustrated generally from left to right in FIG. 1a, yielding % WER REF 22. Stage 2 may then occur after Stage 1, as desired and also in a sequence illustrated generally from left to right in FIG. 1a, yielding % WER DEC 34. Alternative method embodiments provide, as shown in FIG. 1b, that Stage 1 and Stage 2 may occur simultaneously wherein ASR Engine 12 receives PCM REF 18 from Stage 1 while also receiving PCM DEC 30 from Stage 2 and the ASR Engine 12 operates on both signals simultaneously.

It will therefore be readily understood by those persons skilled in the art that the embodiments and alternatives of a System and Method for a High Performance Audio Codec are susceptible of a broad utility and application. While the embodiments are described in all currently foreseeable alternatives, there may be other, unforeseeable embodiments and alternatives, as well as variations, modifications and equivalent arrangements that do not depart from the substance or scope of the embodiments. The foregoing disclosure is not intended or to be construed to limit the embodiments or otherwise to exclude such other embodiments, adaptations, variations, modifications and equivalent arrangements, the embodiments being limited only by the claims appended hereto and the equivalents thereof.

I claim:

1. A system for high performance audio codec comprising:
A CELP-based codec,
An ASR engine; and,
A text comparator.

2. The system for high performance audio codec of claim 1 further comprising the ASR engine including features selected from the group transcription engine, speech analytics engine, voice biometrics engine, interactive voice response (IVR) engine, language learning engine, language translation engine.

3. The system for high performance audio codec of claim 2 further comprising the ASR engine selected from the group embedded, network-based.

4. The system for high performance audio codec of claim 3 further comprising the ASR engine selected from the group phonetic, large vocabulary continuous speech recognition (LVCSR).

5. The system for high performance audio codec of claim 4 further comprising:
an encoder; and,
a decoder.

6. The system for high performance audio codec of claim 5, the encoder further comprising:
an LPC Computation and Formant Analysis Module,
a Dual Stage Data Rate Determination module,
a Vector Quantization (VQ) of LSP Coefficients Module which contains a VQ Codebook,
a Pitch Synthesis and Optimal Pitch Parameter Search Module; and,
an Excitation Codebook Parameter Search Module which contains an Excitation Codebook.

7. The system for high performance audio codec of claim 6 further comprising the CELP-based codec being a MASC codec.

8. The system for high performance audio codec of claim 7 further comprising the MASC codec having n pairs of odd and even roots and (2n)^{th}-order LPC filters wherein 2n equals n multiplied by two.

9. The system for high performance audio codec of claim 8 further comprising the MASC codec having 10^{th}-order LPC filters.

10. The system for high performance audio codec of claim 9 wherein the MASC codec having 10^{th}-order LPC filters generates five pairs of odd and even roots from LPC coefficients.

11. The system for high performance audio codec of claim 10 further comprising a VQ of LSP coefficients module including a VQ codebook and wherein an optimal size and length of the VQ codebook is determined by cross-correlating the auto-correlation coefficients of the speech signal with a determined number of coefficients obtained from the LSP frequencies.

12. The system for high performance audio codec of claim 11 wherein the optimal size and length of the VQ codebook thereby reduces transcription error from the ASR engine.

13. The system for high performance audio codec of claim 12 wherein the optimal size and length of the VQ codebook thereby reduces transcription error from the ASR engine and also enhances voice quality in terms selected from the group PESQ, MOS.

14. The system for high performance audio codec of claim 13 wherein a maximum number of LSP values in the VQ codebook is 2048.

15. The system for high performance audio codec of claim 14 wherein a PCM REF is selected from the group narrow band, wide band.

16. The system for high performance audio codec of claim 15 wherein the narrow band PCM REF is within the range 8 kHz to 11 kHz sampling frequency, inclusive.

17. The system for high performance audio codec of claim 16 wherein the wide band PCM REF is at or above 16 kHz sampling frequency.

18. The system for high performance audio codec of claim 17 wherein the PCM REF includes an audio sample byte size of at least 8 bits.

19. The system for high performance audio codec of claim 18 wherein the PCM REF includes an audio sample byte size selected from the group 8-bit, 16-bit, 32-bit, 64-bit.

20. A system for high performance audio codec including an encoder and a decoder and further comprising:
An LPC computation and formant analysis module,
a dual stage data rate determination module,
an LPC to LSP conversion module,
a VQ of LSP Coefficients module,
an interpolation and LSP to LPC conversion module,
a pitch synthesis and optimal pitch parameter search module,
an excitation codebook parameter search module; and,
a data packing module.

21. The system for high performance audio Codec of claim 20 further comprising the excitation codebook parameter search module having an excitation codebook.

22. The system for high performance audio Codec of claim 21 further comprising the encoder and decoder each having an LSP to LPC conversion module.

23. The system for high performance audio codec of claim 22 further comprising the vector quantization of LSP coefficients module having a VQ codebook.

24. The system for high performance audio codec of claim 23 wherein a maximum number of LSP values in the VQ codebook is 2048.

25. The system for high performance audio codec of claim 24 further comprising the data packing module including a packing portion for the encoder and an unpacking portion for the decoder.

26. The system for high performance audio codec of claim 25 further comprising a CELP-based codec.

27. The system for high performance audio codec of claim 26 further comprising the CELP-based codec being a MASC codec.

28. The system for high performance audio codec of claim 27 further comprising the MASC codec having 10^{th}-order LPC filters.

29. The system for high performance audio codec of claim 28 wherein the MASC codec having 10^{th}-order LPC filters generates five pairs of odd and even roots from LPC coefficients.

30. The system for high performance audio codec of claim 29 wherein an optimal size and length of the VQ codebook is determined by cross-correlating the auto-correlation coefficients of the speech signal with a determined number of coefficients obtained from the LPC filters.

31. The system for high performance audio codec of claim 30 further comprising an ASR engine and wherein the optimal size and length of the VQ codebook thereby reduces transcription error from the ASR engine.

32. The system for high performance audio codec of claim 31 further comprising the ASR engine including one or more features from the group transcription engine, speech analytics engine, voice biometrics engine, interactive voice response (IVR) engine, language learning engine, language translation engine.

33. The system for high performance audio codec of claim 32 further comprising the ASR engine selected from the group embedded, network-based.

34. The system for high performance audio codec of claim 33 further comprising the ASR engine selected from the group phonetic, large vocabulary continuous speech recognition (LVCSR).

35. The system for high performance audio codec of claim 34 wherein the optimal size of the VQ codebook thereby reduces transcription error from the ASR engine and also enhances voice quality as measured in terms selected from the group PESQ, MOS.

36. The system for high performance audio codec of claim 35 wherein a PCM REF is selected from the group narrow band, wide band.

37. The system for high performance audio codec of claim 36 wherein the narrow band PCM REF is within the range 8 kHz to 11 kHz sampling frequency, inclusive.

38. The system for high performance audio Codec of claim 37 wherein the wide band PCM REF is at or above 16 kHz sampling frequency.

39. The system for high performance audio Codec of claim 38 wherein the PCM REF includes an audio sample byte size of at least 8-bit.

40. The system for high performance audio Codec of claim 39 wherein the PCM REF includes an audio sample byte size selected from the group 8-bit, 6-bit, 32-bit, 64-bit.

41. The system for high performance audio Codec of claim 40 wherein an optimal size of the excitation codebook is determined by minimizing a sensitivity-weighted mean square error between input speech and synthesized speech.

42. A method for high performance audio Codec comprising the steps of:
For Stage 1:
Input speech as an uncompressed reference signal is sent to an ASR Engine, bypassing the audio Codec, whereby the ASR engine yields transcribed text from the uncompressed reference signal,
The transcribed text from the uncompressed reference signal is also sent to the text comparator which compares the transcribed text from the uncompressed reference signal received from the ASR engine with the original text in order to determine a percent word error rate, % WER REF, with respect to the uncompressed reference signal,
For Stage 2:
input speech is sent to an encoder of the audio Codec as an uncompressed reference signal,
The encoder yields compressed speech,
The compressed speech from the encoder is sent to a decoder yielding a decoded signal in the form of a decompressed reference signal,
The decompressed reference signal is sent to an ASR Engine yielding transcribed text from the decompressed reference signal,
The transcribed text from the decompressed reference signal is sent to a text comparator which compares the transcribed text from the decompressed reference signal received from the ASR engine with the original text in order to determine a percent word error rate, % WER DEC, with respect to the decompressed signal,
For Stage 3:
a ΔWER is computed as a function of the % WER REF and the % WER Dec.

44. The method for high performance audio Codec of claim 43 further comprising the uncompressed reference signal being a pulse code modulated reference signal, PCM REF.

45. The method for high performance audio Codec of claim 44 further comprising the decompressed reference signal being a pulse code modulated decompressed signal, PCM DEC.

46. The method for high performance audio Codec of claim 45 further comprising the ΔWER computed as the function of the % WER REF and the % WER being an ADWER computed as an absolute difference, ΔWER_{Abs}, between the % WER REF and the % WER Dec wherein ΔWER_{Abs} equals the % WER DEC subtracted from the % WER REF.

47. The method for high performance audio Codec of claim 46 further comprising the ΔWER computed as the function of the % WER REF and the % WER being a RDWER computed as a relative difference, ΔWER_{Rel}, wherein ΔWER_{Rel} equals the ΔWER_{Abs} divided by the % WER REF.

48. The method for high performance audio Codec of claim 47 at Stage 2 the input speech is sent to an encoder of the audio Codec as an uncompressed reference signal further comprising PCM REF being passed through modules within the encoder selected from the group dual stage data rate determination module, vector quantization of LSP coefficients module, pitch synthesis and optimal pitch parameter search module, excitation codebook parameter search module.

49. The method for high performance audio Codec of claim 48 at Stage 2 the input speech is sent to an encoder of the audio Codec as an uncompressed reference signal further comprising PCM REF being passed through the encoder, the encoder modules further comprising:
a data rate determination module,
a vector quantization of LSP coefficients module,
a pitch synthesis and optimal pitch parameter search module; and,
an excitation codebook parameter search module.

50. The method for high performance audio Codec of claim 48 wherein the vector quantization of LSP coefficients module contains a VQ codebook.

51. The method for high performance audio Codec of claim 49 wherein the excitation codebook parameter search module contains an excitation codebook.
